(19) United States
(12) Patent Application Publication
(10) Pub. No.: US 2022/0398291 A1
(43) Pub. Date: Dec. 15, 2022

(54) SMART BROWSER HISTORY SEARCH

(71) Applicant: Microsoft Technology Licensing, LLC, Redmond, WA (US)

(72) Inventors: Tulasi MENON, Hyderabad (IN); Laalithya BODDAPATI, Hyderabad (IN); Parinishtha YADAV, Hyderabad (IN); Prasenjit MUKHERJEE, Hyderabad (IN); Siddharth SHARMA, Hyderabad (IN)

(21) Appl. No.: 17/529,430

(22) Filed: Nov. 18, 2021

(30) Foreign Application Priority Data
Jun. 15, 2021 (IN) 202141026579

(51) Int. Cl. G06F 16/957; G06F 16/951; G06F 16/955

(52) U.S. Cl. CPC G06F 16/9574; G06F 16/951; G06F 16/9566

(57) ABSTRACT

Methods, systems, apparatuses, and computer-readable storage mediums described herein are directed to techniques for smart browser history searching. For example, a user may submit natural language-based search queries to a browser application, which searches for various textual features of web pages maintained by a browser's history, as well as various entity object types included on such web pages based on the search queries. The entity object types include various content included on the web pages, including, but not limited to, products, images, and videos. The browser application also searches for textual features and/or entity object types having a semantic similarity to the search terms of the search queries, thereby providing an advanced search that not only aims to locate web pages based on exact keywords, but also based on the intent and contextual significance of the search terms specified by the user.

### CROSS REFERENCE TO RELATED APPLICATION

This application claims priority to Indian Patent Application No. 202141026579, filed on Jun. 15, 2021, and entitled “SMART BROWSER HISTORY SEARCH,” which is incorporated by reference herein in its entirety.

### BACKGROUND

At any given time, a user's browser history may comprise hundreds of entries corresponding to different web pages that the user previously visited. Each entry specifies the name or title associated with the web page, as well as a date on which the web page was visited. A user may be able to search through the user's browser history by submitting simple search queries that comprise search terms. The browser application returns a listing of web pages that have a name or title that includes all of the exact search terms of the search query.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, apparatuses, and computer-readable storage mediums described herein are directed to techniques for smart browser history searching. For example, a user may submit natural language-based search queries to the browser application, which searches for various textual features of web pages maintained by a browser's history, as well as various entity object types included on such web pages based on the search queries. The entity object types include various content included on the web pages, including, but not limited to, products, images, and videos. The browser application also searches for textual features and/or entity object types having a semantic similarity to the search terms of the search queries, thereby providing an advanced search that not only aims to locate web pages based on exact keywords, but also based on the intent and contextual significance of the search terms specified by the user.

Further features and advantages of the disclosed embodiments, as well as the structure and operation of various embodiments, are described in detail below with reference to the accompanying drawings. It is noted that the disclosed embodiments are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments and, together with the description, further serve to explain the principles of the embodiments and to enable a person skilled in the pertinent art to make and use the embodiments.

FIG. 1 is a block diagram of a system configured to enable a user to search a browser history maintained by a browser application in accordance with an example embodiment.

FIG. 2 is a block diagram of a browser application configured to generate a search index for searching web pages maintained by a browser history of the browser application in accordance with an example embodiment.

FIG. 3 is a block diagram of a system configured to search a browser history of a browser application in accordance with an example embodiment.

FIG. 4 depicts an example browser window in accordance with an example embodiment.

FIG. 5 depicts a flowchart of an example method performed by a browser application for indexing and searching a browser history of the browser application in accordance with an example embodiment.

FIG. 6 depicts a flowchart of an example method performed by a browser application for generating a search index in accordance with an example embodiment.

FIG. 7 depicts a flowchart of an example method performed by a browser application for presenting entity object types via search results in accordance with an example embodiment.

FIG. 8 is a block diagram of an exemplary user device in which embodiments may be implemented.

FIG. 9 is a block diagram of an example processor-based computer system that may be used to implement various embodiments.

The features and advantages of the disclosed embodiments will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Implementations

Embodiments described herein are directed to techniques for smart browser history searching. For example, a user may submit natural language-based search queries to a browser application, which searches for various textual features of web pages maintained by a browser's history, as well as various entity object types included on such web pages based on the search queries. The entity object types include various content included on the web pages, including, but not limited to, products, images, and videos. The browser application also searches for textual features and/or entity object types having a semantic similarity to the search terms of the search queries, thereby providing an advanced search that not only aims to locate web pages based on exact keywords, but also based on the intent and contextual significance of the search terms specified by the user.

In accordance with embodiments described herein, the browser application generates a search index based on textual features and entity object types extracted from web pages navigated to by the browser application. The extraction is performed on each frame displayed in a web page to which the browser application is navigated. In particular, for each frame of the web page, a render process extracts textual features and entity object types therefrom and performs various natural language processing operations (e.g., tokenization, lemmatization, stemming, etc.) thereon. Each frame provides the processed textual features and entity object types to a main browser process (also referred to as the user interface process). The main browser process receives the processed textual features and entity object types for each frame from the render process and generates a search index based thereon. The search index is maintained in memory allocated for the main browser process. A snapshot of the search index is also persisted in long-term storage, such as the hard disk of the computing device on which the browser application is installed.

The natural language processing performed on the textual features and entity object types can be a compute-heavy operation. Performing such processing sequentially in the main browser process would decrease the responsiveness of the browser application and impact the useability of the browser. The techniques described herein mitigate such issues by advantageously performing such processing in a separate process (i.e., the render process) that executes in parallel to the main browser process.

The techniques described herein also mitigate the startup time for the browser application. For instance, because the search index is maintained in volatile system memory (e.g., random access memory (RAM)) during the execution of the browser application, it must be loaded each time the browser application is restarted. This is accomplished by copying the snapshot of the search index into the memory, which can be a compute-heavy operation depending on the size of the snapshot. Loading the search index at the time the browser application is launched (when there are many other processes being loaded and executed) would result in a significant startup delay in which the user is unable to effectively use the browser application. To prevent such an issue, the loading of the search index is performed at subsequent time, for example, responsive to determining that the user is performing a search of the browser history.

In addition, the techniques described herein ensure data privacy. Users are growing increasingly apprehensive of providing their data to third parties, such as technology companies. Users are unsure of how these third parties use their data and whether their data is being sold to other entities. Moreover, the user also has to worry about the security of company servers, as malicious entities are constantly finding new ways to breach corporate security. To remedy this, the techniques described herein may be performed locally at the end user's computing device, thereby protecting the privacy of the user's data.

In embodiments, not only is the user's data protected by performing the techniques described herein locally, but the user interface of the browser application is more responsive, as the user's device is not required to send data to third party servers, e.g., running in a cloud computing environment, for remote natural language processing and wait for results to be utilized locally at the user's device.

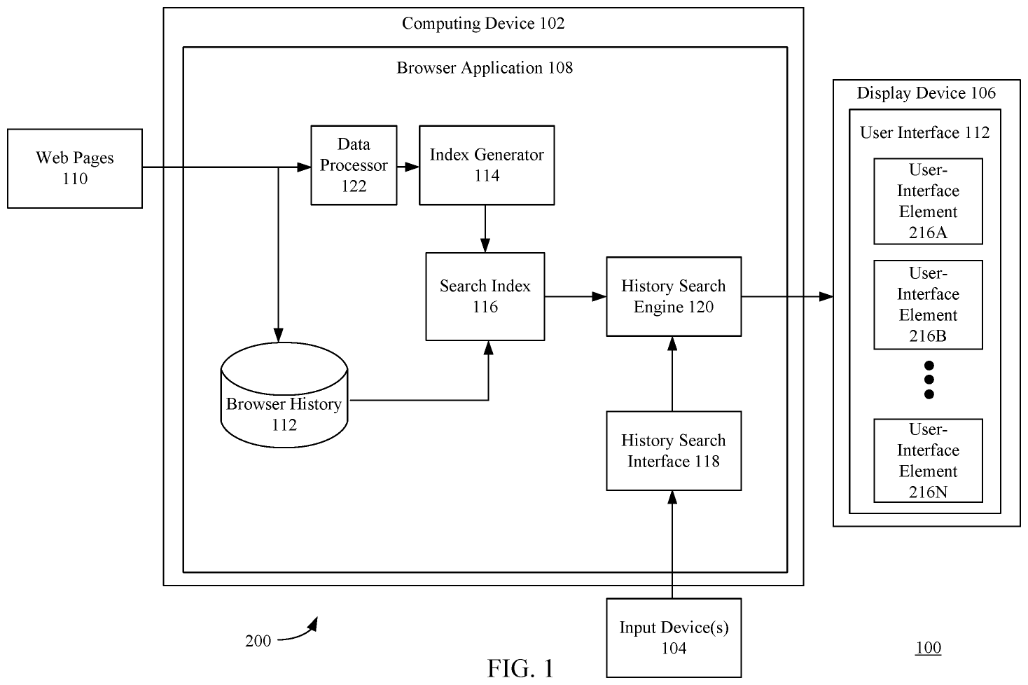

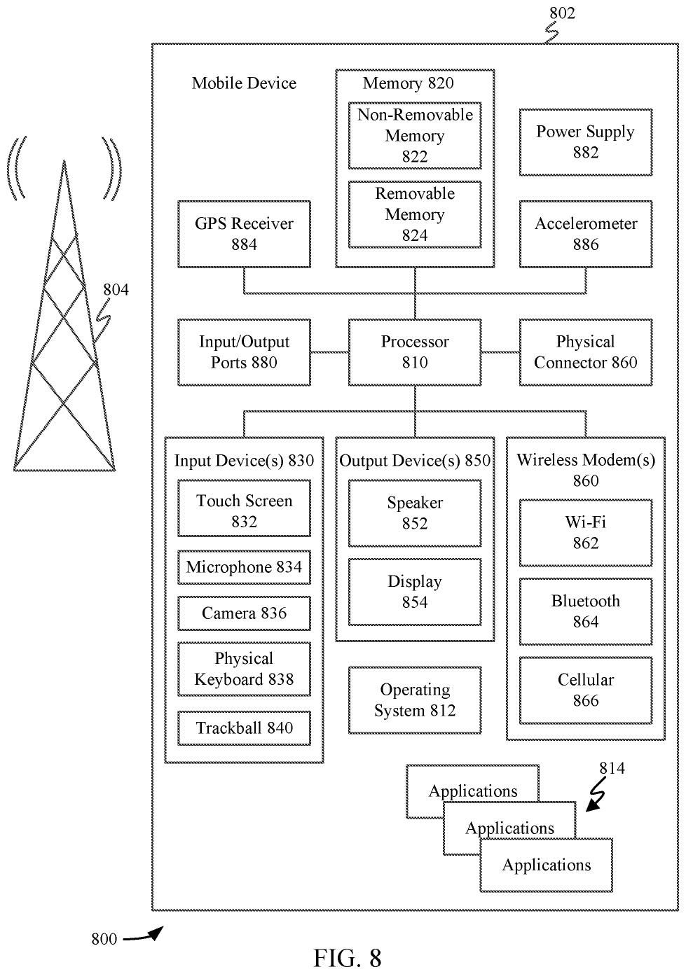

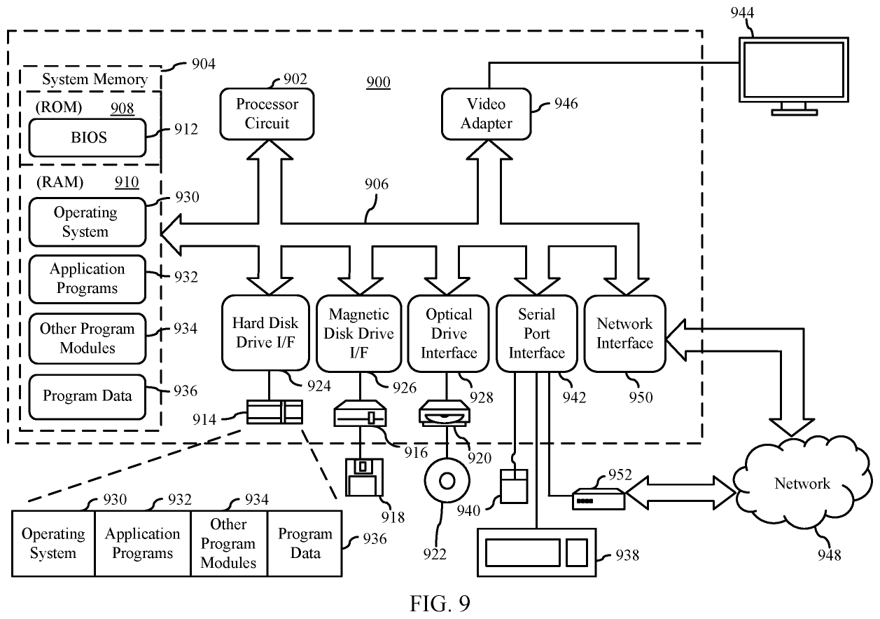

For instance, FIG. 1 is a block diagram of a system 100 configured to enable a user to search a browser history maintained by a browser application in accordance with an example embodiment. As shown in FIG. 1, system 100 comprises a computing device 102, input device(s) 104, and a display device 106. Examples of input device(s) 104 include, but are not limited to, a mouse, a physical keyboard, a mouse. Input device(s) 104 may also comprise a touch screen. In such an example, input device(s) 104 may be incorporated as part of display device 106. Examples of display device 106 include, but are not limited to, a monitor, a touch screen, an LCD display, and LED display, and OLED-based display, and/or the like. While input device(s) 104 and display device 106 are depicted as being external to computing device 102, input device(s) 104 and display device 106 may be incorporated as part of computing device 102 in certain embodiments. Computing device 102 may comprise, for example and without limitation, any end-user computing, such as desktop computer, a laptop computer, a tablet computer, a netbook, a smartphone, or the like. Additional examples of computing device 102 are described below with reference to FIGS. 8 and 9.

Computing device 102 is configured to execute a browser application 108. Browser application 108 (i.e., a web browser) is configured to access web pages 110 and retrieve and/or present content located thereon via a user interface 112 of browser application 108. Browser application 108 stores a listing of web pages 110 that are traversed during web browsing sessions in a browser history 112 maintained by browser application 108. Examples of browser application 108 include Microsoft Edge®, published by Microsoft Corp. of Redmond, Wash., Mozilla Firefox®, published by Mozilla Corp. of Mountain View, Calif., Safari®, published by Apple Inc. of Cupertino, Calif., and Google® Chrome, published by Google Inc. of Mountain View, Calif.

As also shown in FIG. 1, browser application 108 also comprises an index generator 114, a search index 116, a history search interface 118, a history search engine 120, and a data processor 122. Data processor 122 may be configured to extract data from web pages 110 accessed by browser application 108. For instance, data processor 122 may extract data such as a uniform resource identifier (e.g., a uniform resource locator (URL) of each of web pages 110, various textual features, and various entity object types. Examples of textual features include, but are not limited to, a title of each of web pages 110, one or more headings included in each of web pages 110, text from the body of each of web pages 110, snippets of text of each of web pages 110 that describes a web page's content. Some or all of the textual features may be extracted via parsing hypertext markup language (HTML) of each of web pages 110. For example, the title may be obtained by parsing text associated with title tags of each of web pages 110, headings may be obtained by parsing text associated with heading tags (e.g., H1 tags, H2 tags, H3 tags, etc.) of each of web pages 110, the body may be obtained by parsing text associated with body tags of each of web pages 110, the snippets of text may be obtained by parsing text associated with meta tags of each of web pages 110, etc. Entity object types may represent various content included on each of web pages 110, including, but not limited to, products or product names, flight information (e.g., airport codes, airline names, arrival and departure dates, arrival and departure times, etc.), images, videos, etc. As will be described below, supervised machine learning-based techniques may be utilized to identify entity objects types and extract various entity object type attributes.

Data processor 122 may then sanitize extracted uniform resource identifiers, textual features to remove certain words included therein. For instance, data processor 122 may remove certain words of the uniform resource identifiers and/or textual features that are not included in an allow list and/or remove words that are in a deny list, remove certain stop words (e.g., “the,” “is,” “at,” “which,” “on,” etc.), etc. Data processor 122 may then process the remaining words in accordance with various natural language processing-based techniques. For example, data processor 122 may tokenize the sanitized textual features, in which the sanitized textual features are separated into individual tokens. Data processor 122 may then perform lemmatization or stemming on the tokens. When performing lemmatization or stemming, data processor 122 determines the root word of each of the tokenized words. In particular, when performing lemmatization, data processor 122 determines the lemma of each of the tokenized words. For instance, data processor 122 may utilize a dictionary that maps tokenized words to their corresponding root word. When performing stemming, index generator 114 removes the tail end of the tokenized words to derive the stem of the tokenized words. Data processor 122 may also perform similar natural language processing techniques to the extracted entity object type attributes.

After performing the aforementioned natural language processing-based techniques, data processor 122 provides the processed textual features and/or processed entity object type attributes to index generator 114. Index generator 114 generates search index 116 based on the processed textual features and processed entity object type attributes. Search index 116 may comprise a mapping of processed textual features and/or processed entity object type attributes to their respective web page(s) of web pages 110 in which they are included and/or its location with their respective web page(s) of web pages 110. In accordance with an embodiment, search index 116 is an inverted index-based data structure. Search index 116 may be maintained in memory of computing device 102. For example, search index 116 may be stored into the address space of the memory in which one or more processes of browser application 108 are located. Browser application 108 may also periodically generate a snapshot of search index 116 and store a copy of search index 116 in long-term storage, such as the hard disk of computing device 102.

Index generator 114 may be further configured to generate semantic encodings for each of the processed textual features and/or processed entity object type attributes. For instance, index generator 114 may encode such features and/or attributes into fixed length vectors of integer or float values. Words having semantic similarity (e.g., a cosine similarity) to such features and/or attributes would have similar semantic encodings (or vectors). In accordance with an embodiment the semantic encodings are generated using transformer-based machine learning techniques. The semantic encodings may be maintained in search index 116 or another index.

Browser application 108 may also be configured to monitor user interactions with respect to web pages 110. Examples of user interactions include, but are not limited, highlighting of text displayed in a particular web page of web pages 110, the copying and/or pasting of text displayed in a particular web page of web pages 110, an amount of time in which a cursor has hovered over particular text of web pages 110, the clicking of particular text of web pages 110). Browser application 108 may also be configured to determine web pages of web pages 110 that the user frequency interacts with (e.g., via tab switching, frequency of visitation, the dwell time for each of web pages 110 (i.e., a length of time in which a user has spent on a particular web page of web pages 110, etc.).

History search interface 118 is configured to receive queries, such as natural language-based queries. History search interface 118 may comprise a search bar interface. The search bar interface may comprise an address bar of browser application 108 in which a user may enter URLs to which browser application 108 navigates. In accordance with embodiments described herein, the address bar is also configured to accept natural language-based queries for searching for web pages maintained by browser history 112. The search bar interface may also be presented in a history page that displays the URLs maintained by browser history 112. The history page may be displayed responsive to detecting user input (e.g., via interaction with user interface elements presented by browser application 108, detecting a combination of keyboard input (e.g., CTRL+H), etc.). The history page may comprise the search bar interface, by which a user may enter search queries of web pages maintained by browser history 112. It is noted that the foregoing examples of history search interface 118 are purely exemplary and that history search interface 118 may comprise other types of search interfaces.

Natural language-based queries entered via history search interface 118 may be specified as questions (“What were the shoes I was looking at last week?”) to browser application 108 rather than as a simple sequence of search terms. Such queries are provided to history search engine 120. History search engine 120 is configured to sanitize the search query, for example, by removing certain search terms of the search query in a similar manner as described above with reference to index generator 114. History search engine 120 is also configured to tokenize, lemmatize, and/or stem the search terms of search query in a similar manner as described above with reference to index generator 114. History search engine 120 may also be configured to identify filtering terms within the search query by which history search engine 120 filters search results. For instance, the search query may specify time constraints for the web pages to be returned (e.g., “last week,” “two days ago”, etc.). History search engine 120 may also determine semantic encodings for each of the tokenized, lemmatized, or stemmed search terms of the search query.

History search engine 120 may search for web pages of browser history 112 based on the processed search terms and/or the filtering terms of the search query. For instance, history search engine 120 may provide the tokenized and processed search terms to search index 116. Search index 116 may locate the web pages of browser history 112 in which such search terms are included and return the uniform resource identifiers of such web pages. If the search query comprises a time constraint, search index 116 returns the uniform resource identifiers of the web pages that were navigated to by browser application 108 in accordance with the time constraints. For example, if the time constraints specify that that web pages from the last two weeks are to be searched, then search index 116 may return web pages that match the search terms of the search query that were navigated to in the last two weeks.

History search engine 120 is further configured to search for entity object types included in the web pages maintained by browser history 112. For instance, a search query may specify entity object types (e.g., products or product names, images, videos, etc.). History search engine 120 may provide the entity object types to search index 116, and search index 116 may return uniform resource identifiers of web pages maintained by browser history 112 that include such entity object types. Search index 116 may further return a uniform resource identifier from which such entity object types are retrievable to history search engine 120.

History search engine 120 may also compare the semantic encodings of the search terms and/or entity object type attributes of the search queries to the semantic encodings of the indexed terms of search index 116 to determine semantically similar search terms and/or entity object type attributes. This advantageously expands the search to not only the exact search terms or entity object types specified by the user, but search terms or entity object types that are similar thereto.

History search engine 120 outputs the returned search results from search index 116 via user interface 112. For examples, user interface 112 may display user interface elements 216A-216N. Each of user interface elements 216A-216N may correspond to returned search results. Examples of search results include, but are not limited to, uniform resource identifiers of the web pages that are matched to the search query in accordance with the examples described above. Search results may also comprise entity object types (e.g., images, videos, products, etc.). For instance, if the search results returned from search index 116 comprise entity object types, then history search engine 120 may retrieve the and/or present the entity object types (e.g., images, videos, products, etc.). For example, one or more of user interface elements 216A-216N may comprise an image or video representative of an entity object type. Each of user interface elements 216A-216N may be user-selectable. When selectable, browser application 108 may navigate to the web page associated therewith.

History search engine 120 may sort user interface elements 216A-216N based on ranking and/or relevance. The ranking and/or relevance may be based on a distance between semantic encoding vectors of the search terms and the semantic encoding vectors of the terms and/or entity object types maintained by search index 116 (e.g., the closer the distance, the higher the ranking), the level of user interaction with respect to the terms that match the search terms, the number of search terms that are included in a particular web page, etc.

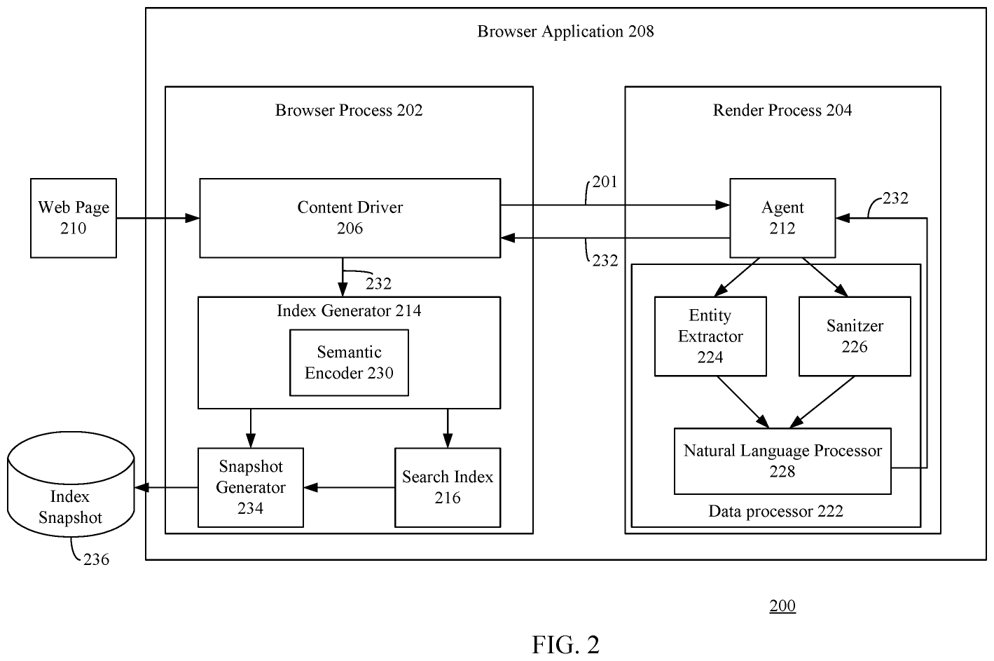

FIG. 2 is a block diagram of a browser application 208 configured to generate a search index 216 for searching web pages maintained by a history of browser application 208 in accordance with an example embodiment. Browser application 208 is an example of browser application 108, as described above with reference to FIG. 1. As shown in FIG. 2, browser application 208 comprises a browser process 202 and a render process 204. Browser process 202 is the main user interface process of browser application 208 that manages the user interface of browser application 208, the tabs of browser application 208 and/or the plugin processes of browser application 208. Browser process 202 is instantiated and loaded in the main memory (e.g., volatile, system memory (e.g., RAM)) of the computing device on which browser application 208 executes (e.g., computing device 102) when browser application 208 is launched. Render process 204 is a tab-specific process that comprises a layout engine to render a web page (e.g., web page 210) to which browser application 208 has navigated. The layout engine interprets the HTML of web page 208 and layouts the HTML into its corresponding tab. In accordance with an embodiment, the layout engine is a Blink-based layout engine. A render process 204 is instantiated for each tab that is opened in browser application 208. Each render process 204 is instantiated and loaded in the main memory of the computing device on which browser application 208 executes.

For each frame of web page 210, browser process 202 instantiates a content driver 206, and render process 204 instantiates an agent 212. Each instantiated content driver 206 acts as a proxy for each frame rendered by a corresponding render process 204. Each instantiated content driver 206 is configured to be communicatively coupled with a corresponding agent 212. For instance, if web page 210 comprises three frames, three content drivers 206 and three agents 212 would be instantiated, where the content driver instantiated for a first frame is communicatively coupled to the agent instantiated for the first frame, the content driver instantiated for a second frame is communicatively coupled to the agent instantiated for the second frame, and the content driver instantiated for a third frame is communicatively coupled to the agent instantiated for the third frame. Each instantiated content driver 206 is configured to communicate with its corresponding agent 212 via an interprocess communication protocol, such as, but not limited to, Mojo.

Upon navigation to web page 210, each instantiated content driver 206 may provide an extraction instruction 201 to its corresponding agent 212. Responsive to receiving extraction instruction 201, agent 212 instructs data processor 222 to extract textual features and entity object types from the frame for which agent 212 is instantiated.

As shown in FIG. 2, data processor comprises an entity extractor 224, a sanitizer 26, and a natural language processor 228. Sanitizer 226 is configured to remove certain words of the uniform resource identifier of web page 210 and/or textual features that are not included in an allow list and/or remove words that are in a deny list, remove certain stop words (e.g., “the,” “is,” “at,” “which,” “on,” etc.), etc. The remaining (or sanitized) words or textual features are provided to natural language processor 228.

Entity extractor 224 is configured to identify entity object types and extract entity object type attributes thereof from each frame of web page 210. For instance, for each frame of web page 210, entity extractor 224 may obtain a document object model (DOM) tree representative of the content included in the frame. The DOM tree may be generated by browser application 208, which parses the HTML of the frame to generate the DOM tree. Each node in the DOM tree represents an object representing a part of web page 210 included in the frame. Examples of objects include, but are not limited to, elements that are representative of titles, headings, body text, etc., and entities. Examples of entities include, but are not limited to, products or product names, flight information, images, videos, etc., included frames of web page 210. Entity object type attributes may specify various attributes of an entity object, including, but not limited to, the entity object type (e.g., an image, a product, a video, etc.), a name of the entity object, etc. For products, the attributes may include, but are not limited, a price of the product, an image associated with the product, a name of the product, a vendor of the product, a uniform resource identifier at which the image may be retrieved, etc. For images and videos, the attributes may include, but are not limited, a name of the image or the video, a uniform resource identifier at which the image or video may be retrieved, etc. For flight information, the attributes may include, but are not limited to, airport codes, airline names, arrival and departure dates, arrival and departure times, etc.

Entity extractor 224 may be configured to convert the DOM tree into a markup language-type format, such as Extensible Markup Language (XML). The converted DOM is analyzed to determine entity object types included therein. In accordance with an embodiment, entity extractor 224 may utilize a supervised machine learning algorithm to identify entity object types included the converted DOM. The entity object types may be declared in the DOM tree using a keyword, such as “entity”. Any number of entity types may be defined using such a declaration. An example of a supervised machine learning algorithm utilized to identify entity object types from the converted DOM includes, but is not limited to, a Naive Bayes-based supervised machine learning algorithm. The supervised machine learning algorithm may be trained using previously-generated DOMs for other web pages. For each identified entity object type, an identifier of the entity object type along with attributes of the entity object type may be provided to natural language processor 228.

Natural language processor 228 may process the sanitized uniform resource identifier associated with web page 210, the sanitized textual features received from sanitizer 226 and/or the entity object types and/or attributes of the entity object types received from entity extractor 224 in accordance with various natural language processing-based techniques. For example, natural language processor 228 may tokenize the sanitized uniform resource identifier, the textual features, and/or the entity object type attributes into individual tokens. Examples of tokenization techniques that may be utilized include, but are not limited to, byte pair encoding (BPE)-based tokenization, unigram-based tokenization, etc. Natural language processor 228 may then perform lemmatization or stemming on the tokens. When performing lemmatization or stemming, natural language processor 228 determines the root word of each of the tokenized words. In particular, when performing lemmatization, natural language processor 228 determines the lemma of each of the tokenized words. For instance, natural language processor 228 may utilize a dictionary that maps tokenized words to their corresponding root word. Examples of lemmatization techniques that may be utilized include, but are not limited to, Wordnet-based lemmatization, Spacy-based lemmatization, Stanford CoreNLP-based lemmatization, etc. When performing stemming, natural language processor 228 removes the tail end of the tokenized words to derive the stem of the tokenized words. Examples of stemming techniques that may be utilized include, but are not limited to, a Lovins-based stemmer, a Porter-based stemmer, a Paice-based stemmer.

The tokens processed for a particular frame by natural language processor 228 are provided to agent 212 associated with the particular frame. Each agent 212 instantiated for a particular frame provides the processed tokens (shown as processed tokens 232) to its corresponding content driver 206. Each content driver 216 instantiated for a particular frame provides the processed tokens received thereby to index generator 214.

Index generator 214 generates search index 216 based on processed tokens 232. Search index 216 may comprise a mapping of processed tokens 232 to its corresponding web page (e.g., web page 210) and/or its location within its corresponding web page. For each entity object type maintained by search index 216, the attributes thereof may also be associated with the entity object type within search index 216. In accordance with an embodiment, search index 216 is an inverted index-based data structure. Search index 216 may be maintained in memory of computing device 102. For example, search index 216 may be stored into the address space of the memory in which browser process 202 is located.

Snapshot generator 234 may periodically generate a snapshot 236 of search index 216 and store snapshot 236 in long-term storage, such as the hard disk of computing device 102. Index snapshot 236 may be loaded into main memory (e.g., volatile, system memory (e.g., RAM)) responsive to determining that the user is performing a search of the browser history rather than during the launch of browser application 208. For instance, index snapshot 236 may be loaded when a user utilizes and/or activates history search interface 118. In particular, browser application 208 may load index snapshot 236 responsive to detecting a combination of keyboard input (e.g., CTRL+H), detecting entry of text in a search bar interface of the history page or the address bar, etc.

It is noted that loading index snapshot 236 responsive to determining that the user is performing a search of the browser history provides a performance enhancement for browser application 208. Loading index snapshot 236 into memory can be compute process-heavy operation depending on the size of index snapshot 236. When browser application 208 launches, there are numerous processes that are being loaded. Thus, performing a compute-heavy operation such as loading index snapshot 236 into memory during startup would result in a significant startup delay. During this delay, the user is unable to effectively utilize browser application 208. By loading index snapshot 236 responsive to determining that the user is performing a search of the browser history, the startup delay is significantly reduced.

In accordance with an embodiment, index snapshot 236 may be utilized across multiple computing devices associated with the user. For instance, a user may utilize browser application 208 on different devices. A user may be associated with a user profile for browser application 208. The user may utilize the same user profile when utilizing browser application 208 on different devices. The user profile may track various browsing activities across different devices. For instance, the user profile may be associated with a centralized browser history that maintains a listing of all the websites navigated to by browser application 208 across the different devices. In accordance with such an embodiment, index snapshot 236 may also be maintained by a centralized server. When browser application 208 determines that the user is performing a search of the browser history, browser application 208 may retrieve index snapshot 236 from the centralized server and load index snapshot 236 into the memory of the device on which browser application 208 is executing to load search index 216.

Index generator 214 may be further configured to generate semantic encodings for each of processed tokens 232. For instance, index generator 214 may comprise a semantic encoder 230. Semantic encoder 230 may encode each of processed tokens 230 into fixed length vectors of integer or float values. Words having semantic similarity (e.g., cosine similarity) to such tokens would have similar semantic encodings (or vectors). In accordance with an embodiment the semantic encodings are generated using transformer-based machine learning techniques, although the embodiments described herein are not limited. The semantic encodings may be maintained in search index 216 or another index.

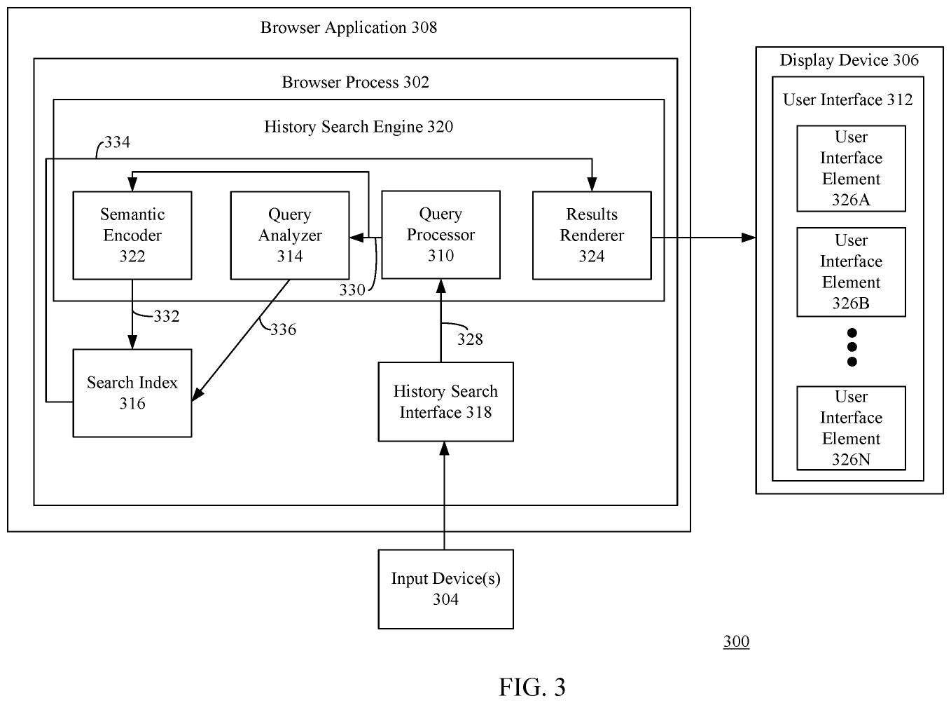

FIG. 3 is a block diagram of a system 300 configured to search a browser history maintained by a browser application 308 in accordance with an example embodiment. As shown in FIG. 3, system 300 comprises browser application 308, display device 306, and input device(s) 304. Browser application 308 is an example of browser application 208, as described above with reference to FIG. 2. Input device(s) 304 and display device 306 are examples of input device(s) 104 and display device 106, as described above with reference to FIG. 1. As shown in FIG. 3, browser application 308 comprises a browser process 302, which is an example of browser process 202. Browser application 302 comprises a history search interface 318, a search index 316, and a history search engine. 320 Search index 316 is an example of search index 216, as described above with reference to FIG. 2. History search engine 320 and history search interface 318 are examples of history search engine 120 and history search interface 118, as described above with reference to FIG. 1. History search engine 320 comprises a query processor 310, a query analyzer 314, a semantic encoder 322, and a results renderer 324.

History search interface 318 is configured to receive search queries, such as natural language-based queries. History search interface 318 may comprise a search bar interface. The search bar interface may comprise an address bar of browser application 308 in which a user may enter URLs to which browser application 308 navigates. In accordance with embodiments described herein, the address bar is also configured to accept search queries for searching for web pages maintained by a browser history of browser application 308 (e.g., browser history 112). The search bar interface may also be presented in a history page that displays the URLs maintained by browser history 112. The history page may be displayed responsive to detecting user input (e.g., via interaction with user interface elements presented by browser application 108, detecting a combination of keyboard input (e.g., CTRL+H), etc.). The history page may comprise the search bar interface by which a user may enter search queries for web pages maintained by browser history 112.

Search queries entered via history search interface 318 are provided to history search engine 318 (shown as search query 328). Search query 328 may be a natural language-based query (e.g., “What were the speakers I was looking at last week?”). Query processor 310 of history search engine 320 is configured to sanitize the search query, for example, by removing certain search terms of the search query in a similar manner as described above with reference to sanitizer 226 of FIG. 2. In the example shown above, the search terms that may be remove may be the terms “what”, “were,” “the”, “I”, “was,” and “looking”. Query processor 310 is also configured to tokenize, lemmatize, and/or stem the search terms of search query in a similar manner as described above with reference to natural language processor 228 of FIG. 2. In the example shown above, the tokens may include (i.e., “speakers” and “last week”). After lemmatization or stemming, the token becomes “speaker”. The sanitized and processed tokens (shown as tokens 330) are provided to query analyzer 314.

Query analyzer 314 is configured to identify filtering terms within the tokens 330 by which history search engine 320 filters search results. For instance, the search query may specify time constraints for the web pages to be returned. In the example shown above, the identified filtering term would be “last week.” Query analyzer 314 may also be configured to detect whether search query 328 specifies entity object types to be searched. For instance, query analyzer 314 may maintain a list of entity object types. Query analyzer 314 may compare each of tokens 330 to the list of entity object types. If one or more of tokens 330 matches an entity object type in the list, then query analyzer 314 determines that the user is attempting to search for entity object types via search query 328. In the example shown above, the determined entity object type may be “speaker,” which is a type of product. Query analyzer 314 may provide a tokenized query 336 comprising tokens 330, specifying any determined entity object types and/or filtering terms to search index 316. Search index 316 returns one or more search results 334 that best matches tokenized query 336. Search result(s) 334 may comprise uniform resource identifier(s) of web pages maintained by browser history 112 that comprise keywords that match tokens of tokenized query 336 and/or entity object types specified by tokenized query 336. If tokenized query 336 specifies a filtering term, such as a time constraint, search results 316 may include uniform resource identifier of web pages that were navigated in accordance with the time constraint. For instance, in the example shown above, uniform resource identifiers of web pages, that were navigated to in the last week, and that contain the keyword “speaker and/or contain entity object types corresponding thereto may be returned via search results 334. In accordance with this example, search index 316 may also return attributes of matching entity object types that were included in the matched web pages via search results 334. Such attributes include, but are not limited, a name of the entity object type, a price associated with the entity object type, a vender associated with entity object type, a uniform resource identifier at which images or videos representative of the matched entity object type may be retrieved, etc.

Semantic encoder 322 is configured to determine semantic encodings 332 for each of processed tokens 330 in a similar manner as described above with reference to semantic encoder 230. For instance, semantic encoder 322 may encode each token of processed tokens 330 into fixed length vectors of integer or float values. Semantic encoder 322 provides semantic encodings 332 generated for each token of processed tokens 330 to search index 316. Search index 316 is configured to also return uniform resource identifiers of web pages maintained by browser history 112 that include keywords having a semantic similarity to tokens of token 330. For instance, search index 316 may maintain semantic encodings of keywords of web pages maintained by browser history 112. Search index 316 may compare semantic encodings 332 to the semantic encodings maintained thereby. Search index 316 may determine whether a measure of semantic similarity between semantic encodings 332 and the semantic encodings maintained by search index 316 is within a predetermined threshold. In response to determining that a particular semantic encoding of semantic encodings 332 has a semantic similarity to a particular semantic encoding maintained by search index 316 that is within a predetermined threshold, search index 316 returns a uniform resource identifier of the web page that is mapped to the particular semantic encoding maintained by search index 316.

Results renderer 324 is configured to output search results 334 from search index 316 via user interface 312, which is an example of user interface 112, as described above with reference to FIG. 1. For examples, user interface 312 may display user interface elements 326A-326N. Each of user interface elements 326A-326N may correspond to a returned result of search results 334. Examples of search results include, but are not limited to, uniform resource identifiers of the web pages that comprise keywords that match tokens of tokenized query 336. Search results may also comprise entity object types (e.g., images, videos, products, etc.). For instance, as described above, search results 334 may further comprise uniform resource identifiers at which the entity object may be retrieved. Results renderer 324 may retrieve the entity object from the uniform resource identifiers and display the entity objects via user interface 312. For instance, one or more of user interface elements 326A-326B may comprise an image retrieved from a uniform resource identifier provided via search results 334, a thumbnail of a video retrieved from a uniform resource identifier, etc. Each of user interface elements 326A-326N may be user-selectable. When selectable, browser application 208 may navigate to the web page associated therewith. User interface elements 326A-326N that comprise a thumbnail of a video may cause playback of the video within user interface 312 upon user selection.

Results renderer 324 may sort user interface elements 326A-326N based on ranking and/or relevance. The ranking and/or relevance may be based on a distance between semantic encoding vectors of the semantic encodings 332 and the semantic encodings terms maintained by search index 316 (e.g., the closer the distance, the higher the ranking), the level of user interaction with respect to the terms that match the search terms, the frequency of user interaction with respect to certain web pages indexed via search index 316, the number of tokens of tokenized query 336 that are included in a particular web page, etc.

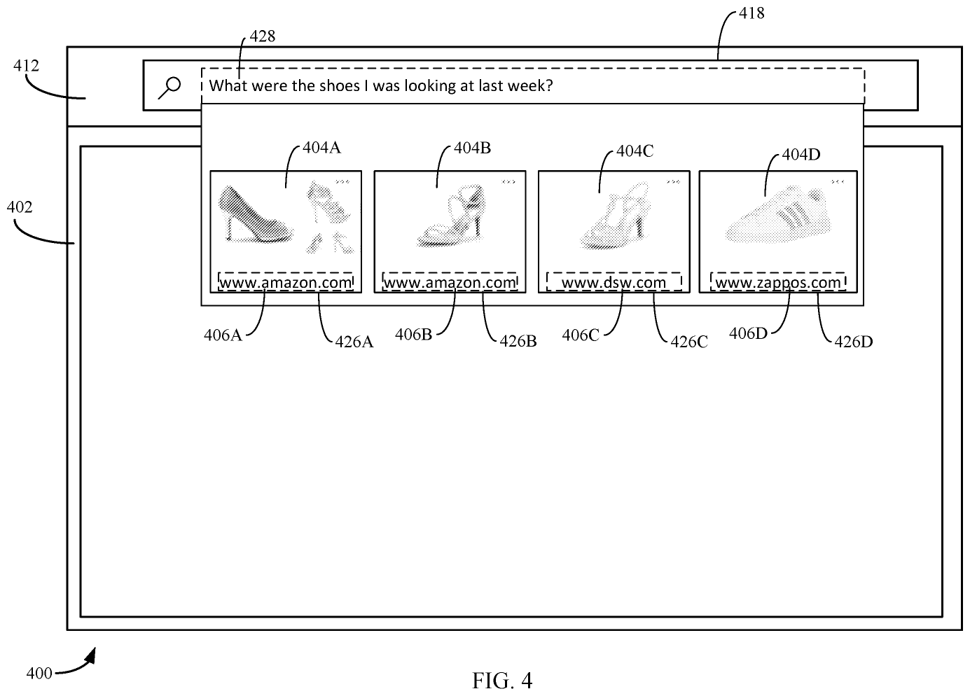

For example, FIG. 4 depicts an example browser window 400 in accordance with an example embodiment. As shown in FIG. 4, browser window 400 comprises a user interface 412 and a display region 402. User interface 412 is an example of user interface 312, as respectively above with reference to FIG. 3. User interface 412 may comprise a plurality of user interface elements, including, but not limited to an address bar 418. User interface 412 may comprise additional user interface elements (e.g., a back button, a forward button, a refresh button) that are not shown for the sake of brevity. Address bar 408 enables a user to enter a uniform resource identifier to which the browser application (e.g., browser application 308) is to navigate and may also display the uniform resource identifier of the web page that is displayable in display region 402 of browser window 400. Address bar 418 may also be utilized to enter a natural language-based search query 428 for web pages maintained in a browser history (e.g., browser history 112) of the browser application. Search query 428 is an example of search query 328, as described above with reference to FIG. 3. Address bar 418 is an example of history search interface 318, as described above with reference to FIG. 3.

Referring again to FIG. 3, search query 428 is provided to query processor 310, which sanitizes and tokenizes search query 428 to generate tokens (e.g., “shoes” and “last week”). Query analyzer 330 analyzes the resulting tokens to determine whether it corresponds to an entity object type. In the present example, query analyzer 314 may determine that the tokens specify a product entity object type (i.e., shoes). Query analyzer 314 generates a tokenized query, which specifies the entity object type. Search index 316 performs a search for web pages maintained by the browser history that include the specified entity object type and/or images and/or videos corresponding to the specified entity object type. Upon determining web pages that comprise the specified entity object type, search index 316 returns search results to results renderer 324. In this example, search results 334 comprises uniform resource identifiers of web pages that include the specified entity object type and uniform resource identifiers at which images and/or videos of the specified entity object may be retrieved. Results renderer 324 displays user interface elements 326A-326N that comprise the uniform resource identifiers of the web pages that include the entity object, along with images of the entity object. For example, as shown in FIG. 4, results renderer 324 may display user interface elements 426A-426N. User interface element 426A comprises a first image 404A, which was retrieved by results renderer 324 from a first uniform resource identifier (e.g., “www.amazon.com/pics/image1.gif”) and a uniform resource identifier 406A “(www.amazon.com”) of the web page that includes first image 404A. User interface element 426B comprises a second image 404B, which was retrieved by results renderer 324 from a second uniform resource identifier (e.g., “www.amazon.com/pics/image2.gif”) and a uniform resource identifier 406B “(www.amazon.com”) of the web page that includes second image 404B. User interface element 426C comprises a third image 404C, which was retrieved by results renderer 324 from a third uniform resource identifier (e.g., “www.dsw.com/pics/image1.gif”) and a uniform resource identifier 406C of the web page that includes third image 404C. User interface element 426D comprises a fourth image 404D, which was retrieved by results renderer 324 from a fourth uniform resource identifier (e.g., “www.zappos.com/pics/image1.gif”) and a uniform resource identifier 406D of the web page that includes first image 404D.

As described above, the uniform resource identifier from which an image is retrieved may be different than the uniform resource identifier of the webpage on which the image is located. However, it is noted that in certain scenarios, the uniform resource identifiers may be the same.

Each of user interface elements 406A-406D may further comprise additional attributes of the entity object depicted thereby. For instance, in the example shown in FIG. 4, one or more of user interface elements 406A-406D may further specify the name of the product depicted thereby, a price of the product depicted thereby, the name of the vendor that sells the product thereby, etc.

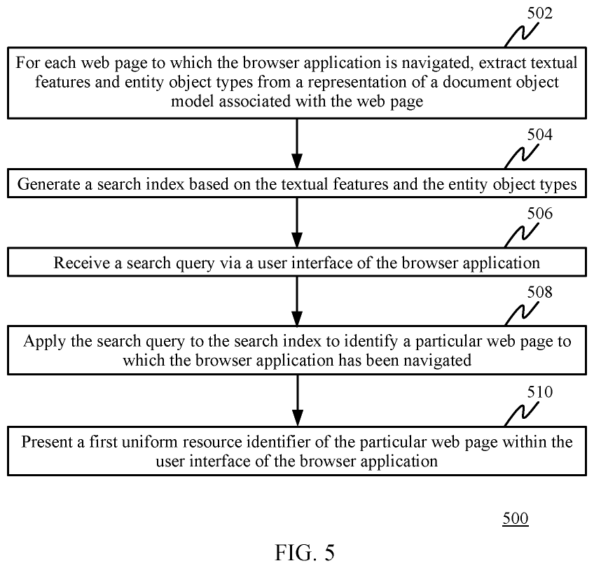

Accordingly, a browser history may be indexed and searched in many ways. For example, FIG. 5 depicts a flowchart 500 of an example method performed by a browser application for indexing and searching a browser history of a browser application in accordance with an example embodiment. In an embodiment, flowchart 500 may be implemented by browser applications 208 and 308 of FIGS. 2 and 3. Accordingly, the method of flowchart 500 will be described with continued reference to browser applications 208 and 308 of FIGS. 2 and 3, although the method is not limited to those implementations. Other structural and operational embodiments will be apparent to persons skilled in the relevant art(s) based on the discussion regarding flowchart 500 and browser applications 208 and 308 of FIGS. 2 and 3.

As shown in FIG. 5, the method of flowchart 500 begins at step 502. At step 502, for each web page to which the browser application is navigated, textual features and entity object types are extracted from a representation of a document object model associated with the web page. For example, with reference to FIG. 2, for each web page (e.g., web page 210) to which browser application 208 is navigated, sanitizer 226 extracts textual features from web page 210 and entity extractor 224 extracts entity object types from a representation of a document object model associated with web page 210.

In accordance with one or more embodiments, the textual features comprise at least one of a title associated with each web page, a heading associated with each page, or a metatag associated with each page.

In accordance with one or more embodiments, extracting entity object types from the representation of the document object model comprises providing the representation of the document object model as an input to a supervised machine learning-based algorithm that is configured to determine the entity object types. For example, with reference to FIG. 2, entity extractor 224 may be configured to obtain and/or convert a DOM tree representative of web page 210 into a markup language-type format, such as XML. Entity extractor 224 may provide the converted DOM tree as an input to a supervised machine learning algorithm to identify entity object types included the converted DOM.

In accordance with one or more embodiments, the entity object types comprise at least one of a product name, an image, or a video.

At step 504, a search index is generated based on the textual features and the entity object types. For example, with reference to FIG. 2, index generator 214 generates search index 216 based on the textual features and the entity object types. For instance, agent 212 may provide the textual features and the entity object types to content driver 206, which provides the textual features and the entity object types to index generator 214.

In accordance with one or more embodiments, the search index is maintained in a memory allocated for the browser application. For example, with reference to FIG. 2, search index 216 is maintained in a memory allocated for browser process 202 of browser application 208.

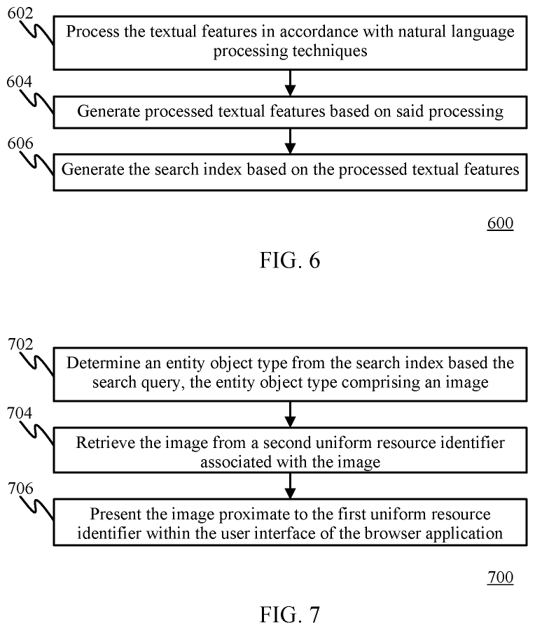

In accordance with one or more embodiments, the search index is generated in accordance with FIG. 6, which is described below.

At step 506, a search query is received via a user interface of the browser application. For example, with reference to FIG. 3, history search interface 318 receives a search query via input device(s) 304.

At step 508, the search query is applied to the search index to identify a particular web page to which the browser application has been navigated. For example, with reference to FIG. 3, the search query is applied to search index 316.

In accordance with one or more embodiments, web pages comprising textual features that have a semantic similarity within a predetermined threshold to search terms in the search query are identified. For example, a determination that a measure of semantic similarity between a search term of the search query and at least one textual feature of the textual features of the search index is within a predetermined threshold. At least one web page to which the browser application has been navigated is identified based on the determination. For example, with reference to FIG. 3, semantic encoder 322 is configured to determine semantic encodings 332 for tokens 330 provided by query processor 310. Semantic encoder 322 provides semantic encodings 332 to search index 316. Search index 316 compares semantic encodings 332 to the semantic encodings generated for the textual features maintained by search index 316 (as described above with reference to semantic encoder 230 of FIG. 2). Search index 316 determines semantic encodings of search index 316 that have a relatively close distance to semantic encodings 332. Textual features having semantic encodings that are relatively close to semantic encoding 332 are determined to have a semantic similarity to the search term(s) of search query 328. After identifying such textual features, web page(s) including such textual features are identified, and the uniform resource identifier(s) of such web page(s) are returned via search results 334.

At step 510, a first uniform resource identifier of the particular web page is presented within the user interface of the browser application. For example, with reference to FIG. 3, results renderer 324 presents a first uniform resource identifier of the particular web page within user interface 312 of browser application 308. For example, as shown in FIG. 4, user interface 412 presents uniform resource identifiers 406A-406D for web pages that are identified based on the application of the search query.

In accordance with one or more embodiments, the search query may comprise a time constraint, which is utilized filter search results returned from the search index. In accordance with such an embodiment, a determination is made that a time constraint is specified by the search query. Responsive to determining that a time constraint is specified by the search query, at least one web page from the search index that was navigated to in accordance with the time constraint is determined. For example, with reference to FIG. 3, search query 328 may specify a time constraint. Query analyzer 314 determines whether search query 328 comprises the time constraint. When applying the search query to search index, query analyzer 314 provides a tokenized query 336 which specifies the time constraint to search index 316. Search index 316 only searches for web pages from search index 316 that are in accordance with the time constraint. For instance, if the time constraint is “the last two weeks”, search index 316 only searches for web pages that were navigated two within the last two weeks.

FIG. 6 depicts a flowchart 600 of an example method performed by a browser application for generating a search index in accordance with an example embodiment. In an embodiment, flowchart 600 may be implemented by browser application 208 of FIG. 2. Accordingly, the method of flowchart 600 will be described with continued reference to browser application 208 of FIG. 2, although the method is not limited to that implementation. Other structural and operational embodiments will be apparent to persons skilled in the relevant art(s) based on the discussion regarding flowchart 500 and browser application 208 of FIG. 2.

As shown in FIG. 6, the method of flowchart 600 begins at step 602. At step 602, the textual features are processed in accordance with natural language processing techniques. For example, with reference to FIG. 2, natural language processor 228 receives sanitized textual features from sanitizer 226. Natural language processor 228 may process the sanitized textual features received from sanitizer 226 in accordance with various natural language processing-based techniques. For example, natural language processor 228 may tokenize the textual features into individual tokens. Natural language processor 228 may then perform lemmatization or stemming on the tokens. When performing lemmatization or stemming, natural language processor 228 determines the root word of each of the tokenized words. In particular, when performing lemmatization, natural language processor 228 determines the lemma of each of the tokenized words. For instance, natural language processor 228 may utilize a dictionary that maps tokenized words to their corresponding root word. When performing stemming, natural language processor 228 removes the tail end of the tokenized words to derive the stem of the tokenized words.

At step 604, processed textual features are generated based on said processing. For example, with reference to FIG. 2, natural language processor 228 generates processed textual features and provides the processed textual features (e.g., processed tokens 232) to agent 212.

At step 606, the search index is generated based on the processed textual features. For example, with reference to FIG. 2, agent 212 provides processed tokens 232 to content driver 206, which provides processed tokens 232 to index generator 214. Index generator 214 generates search index 216 based on processed tokens 232. For instance, index generator 214 generates an inverted index data structure that maps processed tokens 232 to uniform resource identifiers of web pages that include such tokens.

In accordance with one or more embodiments, an entity object types may be presented via search results. For example, FIG. 7 depicts a flowchart 700 of an example method performed by a browser application for presenting entity object types via search results in accordance with an example embodiment. In an embodiment, flowchart 700 may be implemented by browser application 308 of FIG. 3. Accordingly, the method of flowchart 700 will be described with continued reference to browser application 308 of FIG. 3, although the method is not limited to that implementation. Other structural and operational embodiments will be apparent to persons skilled in the relevant art(s) based on the discussion regarding flowchart 700 and browser application 308 of FIG. 3.

As shown in FIG. 7, the method of flowchart 700 begins at step 702. At step 702, an entity object type is determined from the search index based on the search query. The entity object type is an image. For example, with reference to FIG. 3, tokenized query 336 may specify an entity object type, such as a particular image, to be searched via search index 316. Search index 316 searches for the image based on the other tokens describing the image that are specified by tokenized query 336. Search index 316 determines a web page that includes the image and returns the uniform resource identifier of the web page via search results 334. Search index 316 also returns entity object type attributes for the image and returns the attributes via search results 334. The attributes include a uniform resource identifier at which the image is retrievable.

At step 704, to present the entity object type, the image is retrieved from a second uniform resource identifier associated with the image. For example, with reference to FIG. 3, results renderer 324 retrieves the image from the uniform resource identifier at which the image is retrievable.

At step 706, the image is presented proximate to the first uniform resource identifier within the user interface of the browser application. For example, with reference to FIG. 3, results renderer 324 presents the image proximate to the first uniform resource identifier within the user interface of the browser application. For instance, as shown in FIG. 4, user interface 412 presents images 404A-404D proximate to their respective uniform resource identifiers 406A-406D.

### III. Example Mobile and Stationary Device Embodiments

Embodiments described herein may be implemented in hardware, or hardware combined with software and/or firmware. For example, embodiments described herein may be implemented as computer program code/instructions configured to be executed in one or more processors and stored in a computer readable storage medium. Alternatively, embodiments described herein may be implemented as hardware logic/electrical circuitry.

As noted herein, the embodiments described, including in FIGS. 1-7, along with any modules, components and/or subcomponents thereof, as well as the flowcharts/flow diagrams described herein, including portions thereof, and/or further examples described herein, may be implemented in hardware, or hardware with any combination of software and/or firmware, including being implemented as computer program code configured to be executed in one or more processors and stored in a computer readable storage medium, or being implemented as hardware logic/electrical circuitry, such as being implemented together in a system-on-chip (SoC), a field programmable gate array (FPGA), and/or an application specific integrated circuit (ASIC). A SoC may include an integrated circuit chip that includes one or more of a processor (e.g., a microcontroller, microprocessor, digital signal processor (DSP), etc.), memory, one or more communication interfaces, and/or further circuits and/or embedded firmware to perform its functions.

Embodiments described herein may be implemented in one or more computing devices similar to a mobile system and/or a computing device in stationary or mobile computer embodiments, including one or more features of mobile systems and/or computing devices described herein, as well as alternative features. The descriptions of mobile systems and computing devices provided herein are provided for purposes of illustration, and are not intended to be limiting. Embodiments may be implemented in further types of computer systems, as would be known to persons skilled in the relevant art(s).

FIG. 8 is a block diagram of an exemplary mobile system 800 that includes a mobile device 802 that may implement embodiments described herein. For example, mobile device 802 may be used to implement any system, client, or device, or components/subcomponents thereof, in the preceding sections. As shown in FIG. 8, mobile device 802 includes a variety of optional hardware and software components. Any component in mobile device 802 can communicate with any other component, although not all connections are shown for ease of illustration. Mobile device 802 can be any of a variety of computing devices (e.g., cell phone, smart phone, handheld computer, Personal Digital Assistant (PDA), etc.) and can allow wireless two-way communications with one or more mobile communications networks 804, such as a cellular or satellite network, or with a local area or wide area network.

Mobile device 802 can include a controller or processor 810 (e.g., signal processor, microprocessor, ASIC, or other control and processing logic circuitry) for performing such tasks as signal coding, data processing, input/output processing, power control, and/or other functions. An operating system 812 can control the allocation and usage of the components of mobile device 802 and provide support for one or more application programs 814 (also referred to as “applications” or “apps”). Application programs 814 may include common mobile computing applications (e.g., e-mail applications, calendars, contact managers, web browsers, messaging applications) and any other computing applications (e.g., word processing applications, mapping applications, media player applications).

Mobile device 802 can include memory 820. Memory 820 can include non-removable memory 822 and/or removable memory 824. Non-removable memory 822 can include RAM, ROM, flash memory, a hard disk, or other well-known memory devices or technologies. Removable memory 824 can include flash memory or a Subscriber Identity Module (SIM) card, which is well known in GSM communication systems, or other well-known memory devices or technologies, such as “smart cards.” Memory 820 can be used for storing data and/or code for running operating system 812 and application programs 814. Example data can include web pages, text, images, sound files, video data, or other data to be sent to and/or received from one or more network servers or other devices via one or more wired or wireless networks. Memory 820 can be used to store a subscriber identifier, such as an International Mobile Subscriber Identity (IMSI), and an equipment identifier, such as an International Mobile Equipment Identifier (IMEI). Such identifiers can be transmitted to a network server to identify users and equipment.

A number of programs may be stored in memory 820. These programs include operating system 812, one or more application programs 814, and other program modules and program data. Examples of such application programs or program modules may include, for example, computer program logic (e.g., computer program code or instructions) for implementing one or more of touch instrument 102, touch device 104, digitizer 106, eraser manager 108, ML host 112, eraser manager 200, eraser detector 202, eraser reporter 204, position detector 206, and/or orientation detector 208 along with any components and/or subcomponents thereof, as well as the flowcharts/flow diagrams described herein (e.g., flowchart 500, flowchart 600, an/or flowchart 700), including portions thereof, and/or further examples described herein.

Mobile device 802 can support one or more input devices 830, such as a touch screen 832, a microphone 834, a camera 836, a physical keyboard 838 and/or a trackball 840 and one or more output devices 850, such as a speaker 852 and a display 854. Other possible output devices (not shown) can include piezoelectric or other haptic output devices. Some devices can serve more than one input/output function. For example, touch screen 832 and display 854 can be combined in a single input/output device. Input devices 830 can include a Natural User Interface (NUI).

One or more wireless modems 860 can be coupled to antenna(s) (not shown) and can support two-way communications between processor 810 and external devices, as is well understood in the art. Modem 860 is shown generically and can include a cellular modem 866 for communicating with the mobile communication network 804 and/or other radio-based modems (e.g., Bluetooth 864 and/or Wi-Fi 862). At least one wireless modem 860 is typically configured for communication with one or more cellular networks, such as a GSM network for data and voice communications within a single cellular network, between cellular networks, or between the mobile device and a public switched telephone network (PSTN).

Mobile device 802 can further include at least one input/output port 880, a power supply 882, a satellite navigation system receiver 884, such as a Global Positioning System (GPS) receiver, an accelerometer 886, and/or a physical connector 890, which can be a USB port, IEEE 1394 (FireWire) port, and/or RS-232 port. The illustrated components of mobile device 802 are not required or all-inclusive, as any components can be deleted and other components can be added as would be recognized by one skilled in the art.

In an embodiment, mobile device 802 is configured to implement any of the above-described features of flowcharts herein. Computer program logic for performing any of the operations, steps, and/or functions described herein may be stored in memory 820 and executed by processor 810.

FIG. 14 depicts an exemplary implementation of a computing device 1400 in which embodiments may be implemented. For example, embodiments described herein may be implemented in one or more computing devices similar to computing device 1400 in stationary or mobile computer embodiments, including one or more features of computing device 1400 and/or alternative features. The description of computing device 1400 provided herein is provided for purposes of illustration, and is not intended to be limiting. Embodiments may be implemented in further types of computer systems and/or game consoles, etc., as would be known to persons skilled in the relevant art(s).

As shown in FIG. 9, computing device 900 includes one or more processors, referred to as processor circuit 902, a system memory 904, and a bus 906 that couples various system components including system memory 904 to processor circuit 902. Processor circuit 902 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 902 may execute program code stored in a computer readable medium, such as program code of operating system 930, application programs 932, other programs 934, etc. Bus 906 represents one or more of any of several types of bus structures, including a memory bus or memory controller, a peripheral bus, an accelerated graphics port, and a processor or local bus using any of a variety of bus architectures. System memory 904 includes read only memory (ROM) 908 and random access memory (RAM) 910. A basic input/output system 912 (BIOS) is stored in ROM 908.

Computing device 900 also has one or more of the following drives: a hard disk drive 914 for reading from and writing to a hard disk, a magnetic disk drive 916 for reading from or writing to a removable magnetic disk 918, and an optical disk drive 920 for reading from or writing to a removable optical disk 922 such as a CD ROM, DVD ROM, or other optical media. Hard disk drive 914, magnetic disk drive 916, and optical disk drive 920 are connected to bus 906 by a hard disk drive interface 924, a magnetic disk drive interface 926, and an optical drive interface 928, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 930, one or more application programs 932, other programs 934, and program data 936. Application programs 932 or other programs 934 may include, for example, computer program logic (e.g., computer program code or instructions) for implementing embodiments described herein, including browser application 108, data processor 122, index generator 114, search index 116, history search engine 120, history search interface 118, browser application 208, browser process 202, render process 204, content river 206, index generator 214, semantic encoder 230, snapshot generator 234, search index 216, agent 212, data processor 222, entity extractor 224, sanitizer 226, natural language processor 228, browser application 308, browser process 302, history search engine 320, history search interface 318, search index 316, query processor 310, query analyzer 314, semantic encoder 322, and results renderer 324, along with any modules, components and/or subcomponents thereof, as well as the flowcharts/flow diagrams described herein (e.g., flowchart 500, flowchart 600, and/or flowchart 700), including portions thereof, and/or further examples described herein.

A user may enter commands and information into the computing device 900 through input devices such as keyboard 938 and pointing device 940. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 902 through a serial port interface 942 that is coupled to bus 906, but may be connected by other interfaces, such as a parallel port, game port, or a universal serial bus (USB).

A display screen 944 is also connected to bus 906 via an interface, such as a video adapter 946. Display screen 944 may be external to, or incorporated in computing device 900. Display screen 944 may display information, as well as being a user interface for receiving user commands and/or other information (e.g., by touch, finger gestures, virtual keyboard, etc.). In addition to display screen 944, computing device 900 may include other peripheral output devices (not shown) such as speakers and printers.

Computing device 900 is connected to a network 948 (e.g., the Internet) through an adaptor or network interface 950, a modem 952, or other means for establishing communications over the network. Modem 952, which may be internal or external, may be connected to bus 906 via serial port interface 942, as shown in FIG. 9, or may be connected to bus 906 using another interface type, including a parallel interface.

As used herein, the terms “computer program medium,” “computer-readable medium,” and “computer-readable storage medium,” etc., are used to refer to physical hardware media. Examples of such physical hardware media include the hard disk associated with hard disk drive 914, removable magnetic disk 918, removable optical disk 922, other physical hardware media such as RAMs, ROMs, flash memory cards, digital video disks, zip disks, MEMs, nanotechnology-based storage devices, and further types of physical/tangible hardware storage media (including memory 920 of FIG. 9). Such computer-readable media and/or storage media are distinguished from and non-overlapping with communication media and propagating signals (do not include communication media and propagating signals). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 932 and other programs 934) may be stored on the hard disk, magnetic disk, optical disk, ROM, RAM, or other hardware storage medium. Such computer programs may also be received via network interface 950, serial port interface 942, or any other interface type. Such computer programs, when executed or loaded by an application, enable computing device 900 to implement features of embodiments discussed herein. Accordingly, such computer programs represent controllers of the computing device 900.

Embodiments are also directed to computer program products comprising computer code or instructions stored on any computer-readable medium or computer-readable storage medium. Such computer program products include hard disk drives, optical disk drives, memory device packages, portable memory sticks, memory cards, and other types of physical storage hardware.

### IV. Additional Exemplary Embodiments

A system is described herein. The system includes: at least one processor circuit; at least one memory that stores program code configured to be executed by the at least one processor circuit, the program code comprising: a browser application configured to: for each web page to which the browser application is navigated: extract textual features and entity object types from a representation of a document object model associated with the web page; generate a search index based on the textual features and the entity object types; receive a search query via a user interface (UI) of the browser application; apply the search query to the search index to identify a particular web page to which the browser application has been navigated; and present a first uniform resource identifier of the particular web page within the UI of the browser application.

In an embodiment of the system, the textual features comprise at least one of: a title associated with each web page; a heading associated with each page; or a metatag associated with each page.

In an embodiment of the system, the browser application is further configured to: provide the representation of the document object model as an input to a supervised machine learning-based algorithm that is configured to determine the entity object types.

In an embodiment of the system, the entity object types comprise at least one of: a product name; an image; or a video.

In an embodiment of the system, the browser application is further configured to: determine an entity object type from the search index based on the search query, the entity object type comprising an image; retrieve the image from a second uniform resource identifier associated with the image; and present the image proximate to the first uniform resource identifier within the UI of the browser application.

In an embodiment of the system, the browser application is further configured to: determine a time constraint from the search query; and determine at least one web page from the search index that was navigated to in accordance with the time constraint.

In an embodiment of the system, the search index is maintained in a memory allocated for the browser application.

In an embodiment of the system, the browser application is further configured to: process the textual features in accordance with natural language processing techniques; generate processed textual features based on said processing; and generate the search index based on the processed textual features.

In an embodiment of the system, the browser application is further configured to: determine that a measure of semantic similarity between a search term of the search query and at least one textual feature of the textual features of the search index is within a predetermined threshold; and identify at least one web page to which the browser application has been navigated based on said determining.

A method performed by a browser application is also described herein. The method comprises: for each web page to which the browser application is navigated: extracting textual features and entity object types from a representation of a document object model associated with the web page; generating a search index based on the textual features and the entity object types; receiving a search query via a user interface (UI) of the browser application; applying the search query to the search index to identify a particular web page to which the browser application has been navigated; and presenting a first uniform resource identifier of the particular web page within the UI of the browser application.

In an embodiment of the method, the textual features comprise at least one of: a title associated with each web page; a heading associated with each page; or a metatag associated with each page.

In an embodiment of the method, extracting entity object types from the representation of the document object model comprises: providing the representation of the document object model as an input to a supervised machine learning-based algorithm that is configured to determine the entity object types.

In an embodiment of the method, the entity object types comprise at least one of: a product name; an image; or a video.

In an embodiment of the method, applying the search query to the search index to identify a particular web page to which the browser application has been navigated comprises: determining an entity object type from the search index based on the search query, the entity object type comprising an image; and presenting the first uniform resource identifier of the particular web page within the UI of the browser application comprises: retrieving the image from a second uniform resource identifier associated with the image; and presenting the image proximate to the first uniform resource identifier within the UI of the browser application.

In an embodiment of the method, the method further comprises: determining a time constraint from the search query, wherein applying the search query to the search index to identify a particular web page to which the browser application has been navigated comprises: determining at least one web page from the search index that was navigated to in accordance with the time constraint.

In an embodiment of the method, the search index is maintained in a memory allocated for the browser application.

In an embodiment of the method, generating the search index comprises: processing the textual features in accordance with natural language processing techniques; generating processed textual features based on said processing; and generating the search index based on the processed textual features.

In an embodiment of the method, applying the search query to the search index to identify a particular web page to which the browser application has been navigated comprises: determining that a measure of semantic similarity between a search term of the search query and at least one textual feature of the textual features of the search index is within a predetermined threshold; and identifying at least one web page to which the browser application has been navigated based on said determining.

A computer-readable storage medium having program instructions recorded thereon that, when executed by a processor of a computing device, perform a method implemented by a browser application, is also described herein. The method comprises: for each web page to which the browser application is navigated: extracting textual features and entity object types from a representation of a document object model associated with the web page; generating a search index based on the textual features and the entity object types; receiving a search query via a user interface (UI) of the browser application; applying the search query to the search index to identify a particular web page to which the browser application has been navigated; and presenting a first uniform resource identifier of the particular web page within the UI of the browser application.

In an embodiment of the computer-readable storage medium, the textual features comprise at least one of: a title associated with each web page; a heading associated with each page; or a metatag associated with each page.

### V. Conclusion

While various embodiments have been described above, it should be understood that they have been presented by way of example only, and not limitation. It will be apparent to persons skilled in the relevant art that various changes in form and detail can be made therein without departing from the spirit and scope of the embodiments. Thus, the breadth and scope of the embodiments should not be limited by any of the above-described exemplary embodiments, but should be defined only in accordance with the following claims and their equivalents.

What is claimed is:

1. A system, comprising:
at least one processor circuit;
at least one memory that stores program code configured to be executed by the at least one processor circuit, the program code comprising:
a browser application configured to:
for each web page to which the browser application is navigated:
extract textual features and entity object types from a representation of a document object model associated with the web page;
generate a search index based on the textual features and the entity object types;
receive a search query via a user interface (UI) of the browser application;
apply the search query to the search index to identify a particular web page to which the browser application has been navigated; and
present a first uniform resource identifier of the particular web page within the UI of the browser application.

2. The system of claim 1, wherein the textual features comprise at least one of:
a title associated with each web page;
a heading associated with each page; or
a metatag associated with each page.

3. The system of claim 1, wherein the browser application is further configured to:
provide the representation of the document object model as an input to a supervised machine learning-based algorithm that is configured to determine the entity object types.

4. The system of claim 3, wherein the entity object types comprise at least one of:
a product name;
an image; or
a video.

5. The system of claim 1, wherein the browser application is further configured to:
determine an entity object type from the search index based on the search query, the entity object type comprising an image;
retrieve the image from a second uniform resource identifier associated with the image; and
present the image proximate to the first uniform resource identifier within the UI of the browser application.

6. The system of claim 1, wherein the browser application is further configured to:
determine a time constraint from the search query; and
determine at least one web page from the search index that was navigated to in accordance with the time constraint.

7. The system of claim 1, wherein the search index is maintained in a memory allocated for the browser application.

8. The system of claim 1, wherein the browser application is further configured to:
process the textual features in accordance with natural language processing techniques;
generate processed textual features based on said processing; and
generate the search index based on the processed textual features.

9. The system of claim 1, wherein the browser application is further configured to:
determine that a measure of semantic similarity between a search term of the search query and at least one textual feature of the textual features of the search index is within a predetermined threshold; and
identify at least one web page to which the browser application has been navigated based on said determining.

10. A method performed by a browser application, comprising:
for each web page to which the browser application is navigated:
extracting textual features and entity object types from a representation of a document object model associated with the web page;
generating a search index based on the textual features and the entity object types;
receiving a search query via a user interface (UI) of the browser application;
applying the search query to the search index to identify a particular web page to which the browser application has been navigated; and
presenting a first uniform resource identifier of the particular web page within the UI of the browser application.

11. The method of claim 10, wherein the textual features comprise at least one of:
a title associated with each web page;
a heading associated with each page; or
a metatag associated with each page.

12. The method of claim 10, wherein extracting entity object types from the representation of the document object model comprises:
providing the representation of the document object model as an input to a supervised machine learning-based algorithm that is configured to determine the entity object types.

13. The method of claim 12, wherein the entity object types comprise at least one of:
a product name;
an image; or
a video.

14. The method of claim 10, wherein applying the search query to the search index to identify a particular web page to which the browser application has been navigated comprises:
determining an entity object type from the search index based on the search query, the entity object type comprising an image; and
wherein presenting the first uniform resource identifier of the particular web page within the UI of the browser application comprises:
retrieving the image from a second uniform resource identifier associated with the image; and
presenting the image proximate to the first uniform resource identifier within the UI of the browser application.

15. The method of claim 10, further comprising:
determining a time constraint from the search query,
wherein applying the search query to the search index to identify a particular web page to which the browser application has been navigated comprises:
determining at least one web page from the search index that was navigated to in accordance with the time constraint.

16. The method of claim 10, wherein the search index is maintained in a memory allocated for the browser application.

17. The method of claim 10, wherein generating the search index comprises:
processing the textual features in accordance with natural language processing techniques;
generating processed textual features based on said processing; and
generating the search index based on the processed textual features.

18. The method of claim 10, wherein applying the search query to the search index to identify a particular web page to which the browser application has been navigated comprises:
determining that a measure of semantic similarity between a search term of the search query and at least one textual feature of the textual features of the search index is within a predetermined threshold; and
identifying at least one web page to which the browser application has been navigated based on said determining.

19. A computer-readable storage medium having program instructions recorded thereon that, when executed by a processor of a computing device, perform a method implemented by a browser application, the method comprising:
for each web page to which the browser application is navigated:
extracting textual features and entity object types from a representation of a document object model associated with the web page;
generating a search index based on the textual features and the entity object types;
receiving a search query via a user interface (UI) of the browser application;
applying the search query to the search index to identify a particular web page to which the browser application has been navigated; and
presenting a first uniform resource identifier of the particular web page within the UI of the browser application.

20. The computer-readable storage medium of claim 19, wherein the textual features comprise at least one of:
a title associated with each web page;
a heading associated with each page; or
a metatag associated with each page.
